(19) United States
(12) Patent Application Publication
(10) Pub. No.: US 2022/0391418 A1
(43) Pub. Date: Dec. 8, 2022

(54) OPERATING A STORAGE SERVER WITH A STORAGE VOLUME

(71) Applicant: KYNDRYL, INC., New York, NY (US)

(72) Inventors: Armin Fritsch, Wandlitz (DE); Holger Wittmann, Heidelberg (DE); Marcus Roskosch, Frechen (DE); Rene Funk, Brotterode-Trusetal (DE); Utz Bacher, Dettenhausen (DE)

(21) Appl. No.: 17/303,798

(22) Filed: Jun. 8, 2021

(51) Int. Cl. G06F 16/28; G06F 16/215; G06F 16/23; G06F 16/242

(52) U.S. Cl. CPC G06F 16/287; G06F 16/215; G06F 16/2322; G06F 16/244; G06F 16/288

(57) ABSTRACT

A method, computer system, and a computer program product for operating at least one storage server. The present invention may include receiving an access request for at least one storage volume of at least one storage server. The present invention may include collecting data for the at least one storage volume, wherein the at least one storage volume has a corresponding unique volume identifier. The present invention may include storing at least the data for the at least one storage volume and the unique volume identifier in a database, the data being comprised of metadata and subset data, wherein the metadata is comprised of configuration and status information for the at least one storage volume, and wherein the subset data is a set of predefined selection criteria based on a respective computer server.

### BACKGROUND

The present invention relates in general to data processing systems, in particular, to a method and a system for operating at least one storage server with at least one storage volume for storing data from and loading by at least one compute server, a computer program product and a data processing system.

Information Technology Asset Management (ITAM) of large-scale storage systems including information technology (IT) inventory through one or more Configuration Management Databases (CMBD) may be out of date and unreliable. These large-scale storage systems may utilize agent systems whereby one or more agents are installed in an Operating System (OS) or agent-less systems in which the agent-less systems scan for open ports and/or establish a remote connection to execute commands in-band.

Agent-systems may rely on agents installed in operating systems (OS) in delivering information to a central database. Agent-systems may not always run, may run improperly, may not have operating system (OS) and operating system (OS) supported release and/or dependency, and may require credentials to install and/or operate agents as needed. Agents have an operating system (OS) level view which may be disconnected from a larger topology view on a storage area network (SAN)/network scope. Agents may have OS dependencies and only run on certified operating systems. Disk replication/mirroring information is not visible from an OS perspective and may not be considered.

Agent-less systems scan for open ports or establish a remote connection to execute commands in-band. Network connectivity may need to be in place and a port scan may only deliver limited information and details. Credentials may be needed to execute commands and may require secure storage.

Furthermore, both agent and agent-less systems may require remote access and/or remote execution which may be disadvantageous for at least security reasons.

### SUMMARY

Embodiments of the present invention disclose a method, computer system, and computer program product for operating a storage server. The present invention may include receiving an access request for at least one storage volume of at least one storage server. The present invention may include collecting data for the at least one storage volume, wherein the at least one storage volume has a corresponding unique volume identifier. The present invention may include storing at least the data for the at least one storage volume and the unique volume identifier in a database, the data being comprised of metadata and subset data, wherein the metadata is comprised of configuration and status information for the at least one storage volume, and wherein the subset data is a set of predefined selection criteria based on a respective computer server.

### BRIEF DESCRIPTION OF THE SEVERAL VIEWS OF THE DRAWINGS

The present invention together with the above-mentioned and other objects and advantages may best be understood from the following detailed description of the embodiments, but not restricted to the embodiments. The various features of the drawings are not to scale as the illustrations are for clarity in facilitating one skilled in the art in understanding the invention in conjunction with the detailed description. In the drawings:

FIG. 1 depicts a component diagram of a system for operating one or more storage servers with at least one storage volume each for storing data and loading from by a compute server according to an embodiment of the invention.

FIG. 2 depicts a detailed component diagram of the storage servers in the system according to FIG. 1.

FIG. 3 depicts a component diagram of a system for operating one or more storage servers with at least one storage volume each for storing data and loading from by a compute server according to a further embodiment of the invention.

FIG. 4 depicts a detailed component diagram of the storage servers in the system according to FIG. 3.

FIG. 5 depicts a flow chart for operating a data inspector of the system according to an embodiment of the invention.

FIG. 6 depicts a flow chart for operating a trace logger of the system according to an embodiment of the invention.

FIG. 7 depicts a flow chart for operating a landscape level aggregator of the system according to a further embodiment of the invention.

FIG. 8 depicts an example embodiment of a data processing system for executing a method according to the invention.

### DETAILED DESCRIPTION

In the drawings, like elements are referred to with equal reference numerals. The drawings are merely schematic representations, not intended to portray specific parameters of the invention. Moreover, the drawings are intended to depict only typical embodiments of the invention and therefore should not be considered as limiting the scope of the invention.

The illustrative embodiments described herein provide a system for operating at least one storage server with at least one storage volume for storing data and loading from by at least one compute server, the storage volume assigned with a unique volume identifier, wherein configuration and status information for the respective storage volume and the respective compute server 50 is stored in a datastore (e.g., database). At least a data inspector, a trace logger and an interface to the datastore (e.g., database) are implemented in the storage server, wherein the data inspector is configured to, in case of a certain event (e.g., I/O request, Input/Output Request, Read/Write Request) or the expiration of a time interval, collecting data for at least one storage volume with the corresponding unique volume identifier respectively and storing the collected data in the datastore (e.g., database) together with the respective unique volume identifier of the corresponding storage volume, the collected data comprising metadata regarding the respective storage volume and a subset of the data stored on the respective storage volume, wherein the subset is determined based on a set of predefined selection criteria related to the compute server.

The illustrative embodiments may further be used for a method for operating at least one storage server with at least one storage volume for storing data from and loading by at least one compute server, the at least one storage volume assigned with a unique volume identifier, wherein configuration and status information for the respective storage volume and the respective compute server is stored in a datastore (e.g., database). The method comprises, in case of a certain event (e.g., I/O request, Input/Output Request, Read/Write Request) or the expiration of a time interval, collecting data for the at least one storage volume with the corresponding unique volume identifier respectively and storing the collected data in the datastore (e.g., database) together with the respective unique volume identifier of the corresponding storage volume, the collected data comprising metadata regarding the respective storage volume and a subset of the data stored on the respective storage volume, wherein the subset is determined based on a set of predefined selection criteria related to the respective compute server.

As there is no system without a storage volume a central storage infrastructure is used to assemble a full view of the IT landscape of a data processing system. This may be applied typically for an SAN architecture, but can also be used for virtual systems, such as VMware vSAN, or a cloud block storage, a network attached storage (NAS), or the like.

Each server leaves “traces” on storage servers/subsystems due to I/O processes. An assumption is that all defined storage volumes provide storage for all servers and no local disks are used.

On a first level each I/O request (e.g., Input/Output request, Read/Write request) to a storage volume shows the server using it has been active. It may be logged when a compute server uses a storage volume. Thus, a trace may be logged that points out, that the storage volume is in use and by which source identified by a unique identifier, such as an IP/MAC/WWPN address.

On a second level additional information may be centrally gathered by looking into recently used storage volumes. Data like hostname, network settings, hardware configuration may be collected from a boot log. Storage volumes which are encrypted by the OS or a hypervisor need integration with a key management system (KMS) or will only reveal part of the above information, potentially used in a confidential computing trusted execution environment (TEE) to protect exposure of any keys.

A SAN subsystem and SAN data, e.g. zoning, also can provide insight into a mirroring setup.

Advantages are the method according to embodiments of the invention uses current system data, right from the source, and no static data, no outdated shadow datastores.

There are no dependencies on agents and no issues of agent-less systems.

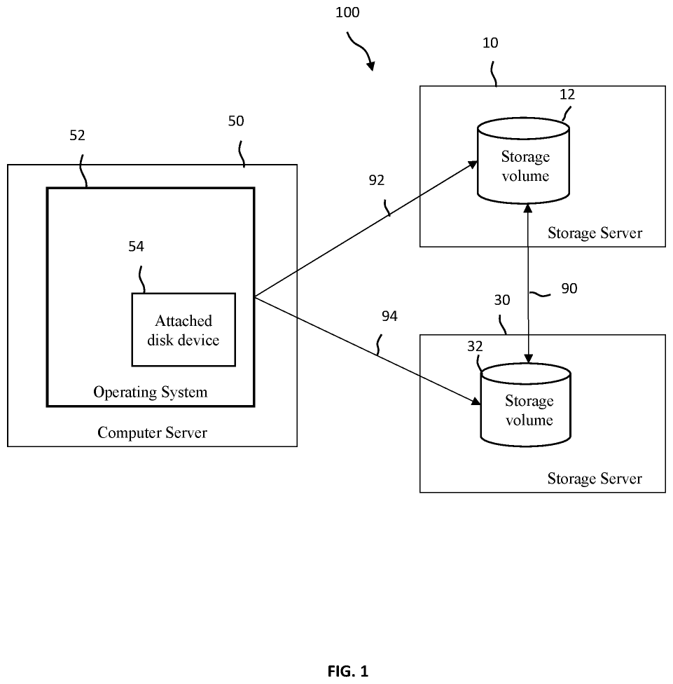

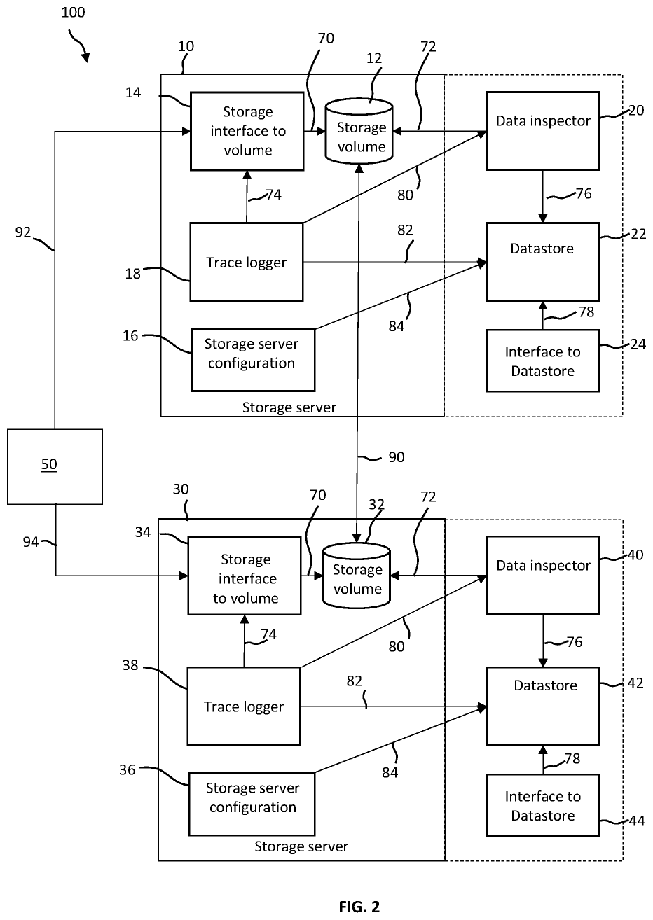

FIG. 1 depicts a component diagram of a system 100 for operating two storage servers 10, 30 with at least one storage volume 12, 32 each for storing data and loading from by a compute server 50 according to an embodiment of the invention. FIG. 2 depicts a detailed component diagram of the storage servers 10, 30 in the system 100 according to FIG. 1.

The structure of the storage servers 10, 30 is identical. The storage servers 10, 30 comprise a storage volume 12, 32 each with a storage interface 14, 34 to the storage volume 12, 32. There exists also a storage server configuration 16, 36 to the storage volumes 12, 32. Both storage volumes 12, 32 are connected via a storage server replicate connection 90.

The compute server 50 is running an attached disk device 54 on an operating system (OS) 52 and uses I/O processes 92, 94 to operate via the storage interfaces 14, 34 on the storage volumes 12, 32.

In a typical environment, there may exist many compute servers 50 that consume storage on the storage servers 10, 30.

According to an embodiment of the invention at least a data inspector 20, 40, a trace logger 18, 38, a storage server element datastore 22, 42 (e.g., database 22, 24) and an interface 24, 44 to the datastore (e.g., database) 22, 42 are implemented in the storage server 10, 30.

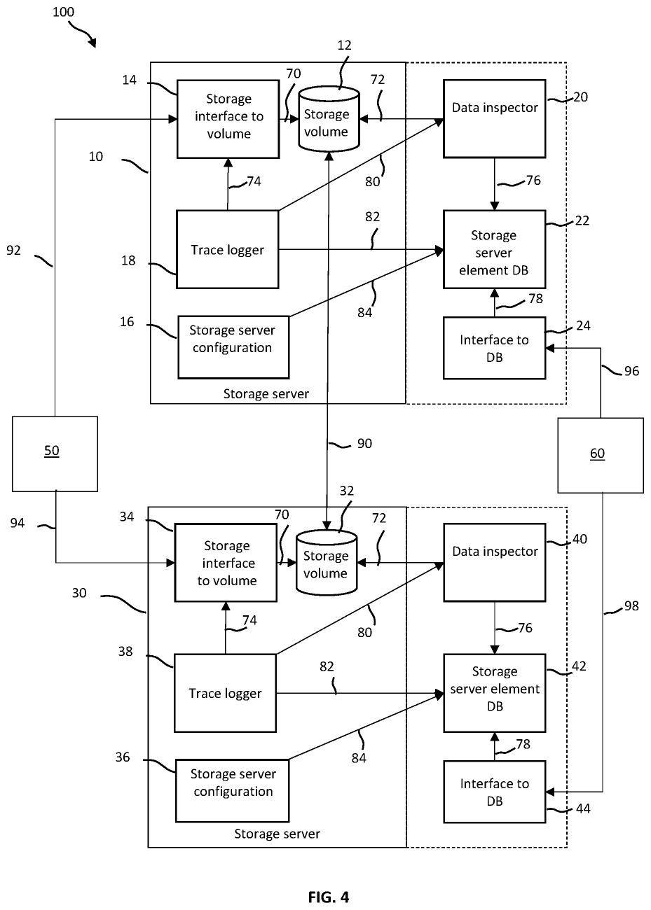

In a further embodiment the data inspector 20, 40, the datastore (e.g., database) 22, 42, and the interface 24, 44 may be located outside the storage server 10, 30, as is indicated by the broken line boxes comprising the components in the FIGS. 2 and 4.

The storage interface 14, 34 forwards data to the storage volume 12, 32 via connections 70. The data inspector 20, 40 analyzes data on the storage volume 12, 32 via connection 72 and transmits queries and send details to the datastore (e.g., database) 22, 42 via connection 76. The interface 24, 44 extracts information from the datastore (e.g., database) 22, 42 via connection 78. The trace logger 18, 38 monitors processes on the storage interface 14, 34 via connection 74, optionally requests validation from the data inspector 20, 40 via connection 80 and sends details to the datastore (e.g., database) 22, 42 via connection 82. The storage server configuration 16, 36 also transmits details to the datastore (e.g., database) 22, 42 via the connection 84.

The storage volume 12, 32 is assigned with a unique volume identifier. Configuration and status information for the respective storage volume 12, 32 and the respective compute server 50 is stored in the datastore (e.g., database) 22, 42.

The data inspector 20, 40 collects, in case of a certain event (e.g., I/O request, Input/Output Request, Read/Write Request) or the expiration of a time interval, data for the storage volume 12, 32 with the corresponding unique volume identifier respectively and stores the collected data in the datastore (e.g., database) 22, 42 together with the respective unique volume identifier of the corresponding storage volume 12, 32. The collected data comprises metadata regarding the respective storage volume 12, 32 and a subset of the data stored on the respective storage volume 12, 32. The subset is determined based on a set of predefined selection criteria related to the compute server 50.

The subset of the data stored on the respective storage volume 12, 32 may comprise selected configuration information of the compute server 50, as e.g. a host name, network and/or storage configuration data.

Further, the subset of the data stored on the respective storage volume 12, 32 may comprise selected information of an operation of the compute server 50, as e.g. a hardware configuration for an inventory management and/or a last booting time or log messages.

Advantageously the unique volume identifier of the respective storage volume 12, 32 and a unique server identifier of the respective compute server 50 may be stored for each access of the respective storage volume 12, 32 by the respective compute server 50 by information processing, as e.g. event stream processing.

For this purpose, the respective compute server 50 is assigned with a unique server identifier. The system 100 stores the unique server identifier of the compute server 50 together with the unique volume identifier of the storage volume 12, 32 by information processing and/or in the datastore (e.g., database) 22, 42.

Further, the storage server 10, 30 may comprise a temporary cache for storing the unique volume identifier of the storage volume 12, 32 and/or the unique server identifier of the compute server 50 and/or a current timestamp for an access of the respective storage volume 12, 32.

Advantageously, the unique volume identifier of the storage volume 12, 32 and the unique server identifier of the respective compute server 50 and the current timestamp for an access of the respective storage volume 12, 32 may be stored in the temporary cache of the storage server 10, 30.

Particularly in case of a certain event (e.g., I/O request, Input/Output Request, Read/Write Request) or the expiration of a time interval, at least the unique volume identifier of the respective storage volume 12, 32 is stored in the datastore (e.g., database) 22, 42.

A current timestamp for each access of the respective storage volume 12, 32 by the respective compute server 50 may be registered. Then the system 100 stores the latest timestamp with at least the unique volume identifier of the storage volume 12, 32 by information processing and/or in the datastore (e.g., database) 22, 42.

Thus, according to embodiments of the invention the system 100 may determine if the respective storage volume 12, 32 and/or the respective compute server 50 associated with respective unique volume and server identifiers in the datastore (e.g., database) 22, 42 are still active. For each inactive storage volume 12, 32 and/or compute server 50 the corresponding entries in the datastore (e.g., database) 22, 42 may be deleted.

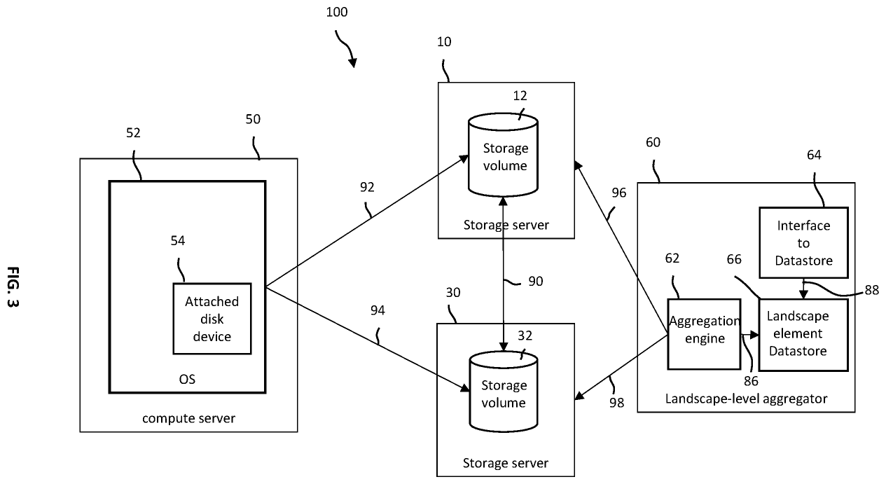

FIG. 3 depicts a component diagram of a system 100 for operating storage servers 10, 30 with at least one storage volume 12, 32 each for storing data and loading from by a compute server 50 according to a further embodiment of the invention. FIG. 4 depicts a detailed component diagram of the storage servers 10, 30 in the system 100 according to FIG. 3.

Storage servers 10, 30 as well as the compute server 50 may be identical to the embodiment shown in FIG. 1.

The system 100 further exhibits a landscape level aggregator 60, comprising an aggregation engine 62, a landscape element datastore 66 (e.g., landscape element database 66) and an interface 64 to the landscape element datastore 66 (e.g., landscape element database 66). The aggregation engine 62 stores data in the landscape element datastore 66 via the connection 86, whereas the interface 64 extracts information from the datastore 66 via the connection 88.

The landscape level aggregator 60 is configured to query the content of the datastore 22, 42 using a network connection 96, 98 to the storage server 10, 30. The landscape aggregator 60 further analyzes the datastore 22, 42 in order to provide information on all compute servers 50 concerning their recency and configuration using the storage servers 10, 30. Additionally or alternatively the landscape aggregator 60 further aggregates information across several storage servers 10, 30 in order to include a mirroring/replication configuration of respective storage volumes 12, 32 across individual storage servers 10, 30.

The landscape level aggregator 60 may further synchronize data from subordinated storage server datastores 22, 42 and/or stores the aggregated information on the landscape element datastore 66.

The content of the datastore 22, 42 is queried using the network connection 96, 98 to the storage server 10, 30. The datastore 22, 42 is analyzed to provide information on all compute servers 50 concerning its recency and configuration using the storage servers 10, 30.

Advantageously, the landscape level aggregator 60 thus aggregates information across several storage servers 10, 30 to include a mirroring/replication configuration of storage volumes 12, 32 across individual storage servers 10, 30.

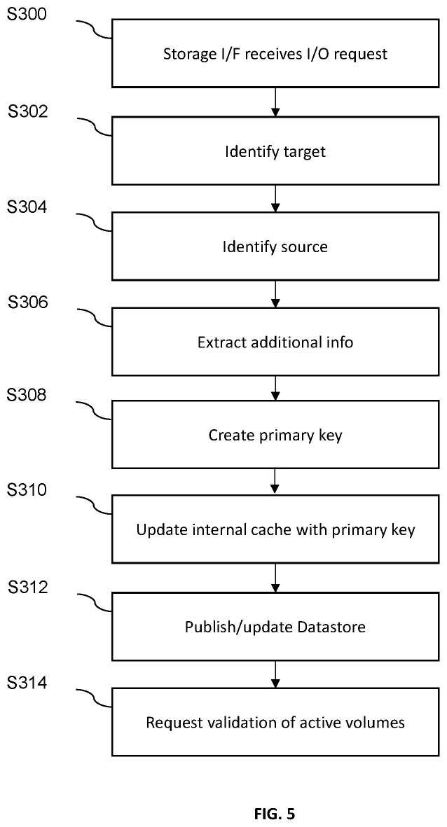

FIG. 5 depicts a flow chart for operating the trace logger 18, 38 of the system 100 according to an embodiment of the invention.

In step S300 the storage interface 14, 34 receives an I/O request.

In step S302 the trace logger 18, 38 identifies the target storage volume 12, 32 of the I/O request, by the unique volume identifier, e.g. a logical unit number (LUN).

In step S304 the trace logger 18, 38 identifies the source of the I/O request by the unique server identifier, e.g. via a world-wide port name (WWPN).

Optionally, the trace logger 18, 38 extracts in step S306 additional information from the I/O request, e.g. fingerprinting of a write request.

Next, the trace logger 18, 38 creates in step S308 a primary key, with a unique identifier from data. The primary key can be e.g. the volume identifier.

Then, in step S310, the trace logger 18, 38 updates the internal cache with the primary key, the timestamp for the last activity, the source, the target, as well as with optional additional information. If it is the same source and the same target only the timestamp is updated in the temporary cache.

Next, in step S312, the trace logger 18, 38 regularly publishes/updates the datastore 22, 42.

In step S314, the trace logger 18, 38 requests validation of active volumes from the data inspector 20, 40 and clears the temporary cache.

According to an alternative embodiment, the data inspector 20, 40 queries the datastore 22, 42.

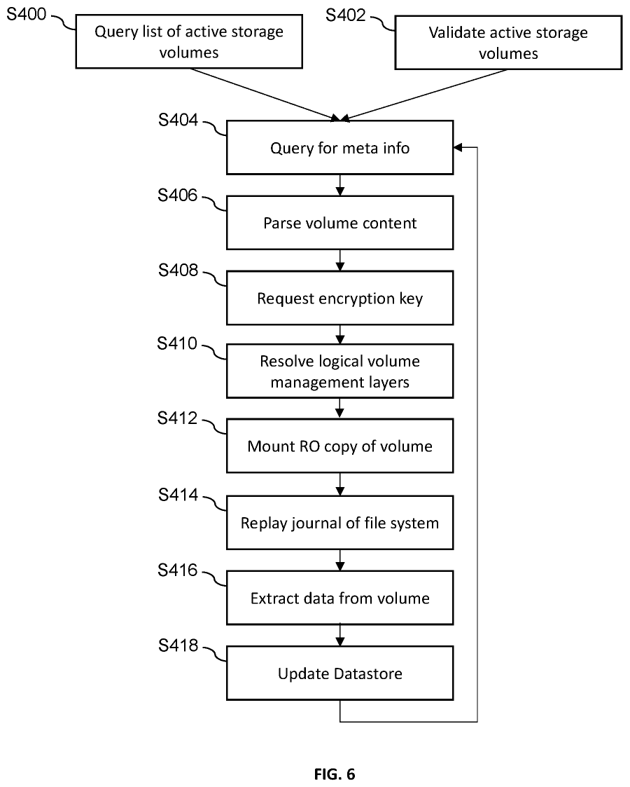

FIG. 6 depicts a flow chart for operating the data inspector 20, 40 of the system 100 according to an embodiment of the invention.

In step S400 the data inspector 20, 40 queries a list of active storage volumes 12, 32 from the datastore 22, 42.

Alternatively, the data inspector 20, 40 may be triggered in step S402 by the trace logger 18, 38 to validate those storage volumes 12, 32 where the trace logger 18, 38 determined recent activity.

For each volume to be processed the data inspector 20, 40 carries out in a loop the following steps.

In step S404 the data inspector 20, 40 queries the storage server 10, 30 for meta information, e.g. mirroring information, type, size of the storage volume 12, 32.

Next in step S406 the data inspector 20, 40 parses the storage volume content in a so-called “deep inspection” to derive additional information to qualify a certain landscape element, as e.g. a hostname, an OS level, or the like.

Due to a preferred embodiment, in step S408, the data inspector 20, 40 optionally requests an encryption key from the KMS to access the encrypted storage volume 12, 32.

Next, in step S410, also optionally, the data inspector 20, 40 resolves any logical volume management layers to access the payload.

In step S412 the data inspector 20, 40 mounts a read-only copy of the storage volume 12, 32.

In step S414 the data inspector 20, 40 replays a journal of a file system, if available, on its logical view of the storage volume 12, 32.

Next, in step S416, the data inspector 20, 40 extracts data from the storage volume 12, 32, e.g. a last boot date (/var/log/messages), a hardware configuration (/var/log/messages), a hostname (/etc/hostname), a uuid (uuid, ssh public key, . . . ), a network configuration (/etc/network . . . /), a storage configuration (/etc/ . . . ) including hardware configuration like WWPN, all disks/volumes that are attached by default (/etc) or dynamically (/var/log/messages), host-based mirroring.

In step S418 finally the data inspector 20, 40 writes the gained information of the two previous steps S414, S416 to update the storage server element datastore 22, 42.

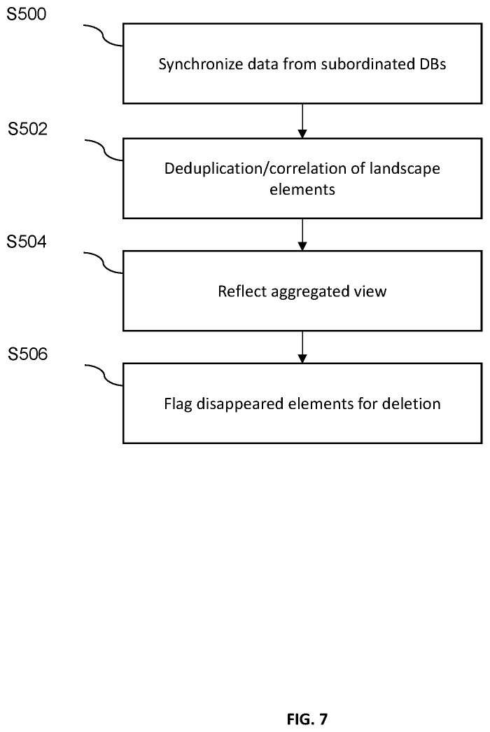

FIG. 7 depicts a flow chart for operating the landscape level aggregator 60 of the system 100 according to a further embodiment of the invention.

Aggregation may be required to get a view on the landscape when several storage servers 10, 30 are used.

In step S500 the landscape level aggregator 60 leverages its so-called “aggregation engine” 62 to synchronize data from subordinated storage server element datastores 22, 42.

In step S502 the aggregation engine 62 performs a de-duplication/correlation of landscape elements and determines additional relationships of storage volumes 12, 32 which interrelate due to mirroring configurations. Correlation may be done on unique identifiers of a server, e.g. hostname, uuid, or the like.

Next in step S504, the landscape element datastore 66 reflects the aggregated view.

In step S506 elements which got disappeared from a leaf datastore will be flagged for deletion in the landscape level datastore 66 and removed ultimately after a specific grace period.

Advantageously, host-based mirroring may be detected by the data inspector 20, 40 due to the server configuration. The landscape level aggregator 60 correlates mirrored storage volumes 12, 32 of the same storage server 10, 30, e.g. through identification by uuid plus host-based mirroring configuration of the server 10, 30.

Concerning storage server-based mirroring, a volume mirroring configuration is only provided by the storage server 10, 30 and not detected by the data inspector 20, 40. The landscape level aggregator 60 provides a consistent view across all involved storage servers 10, 30.

It may be conceivable to have host-based mirroring where individual volumes are replicated/mirrored by storage servers, which can be detected by the landscape level aggregator 60 through above means. Mirroring can mean more than just two mirrors.

Embodiments of the invention may be applied on logical storage infrastructure like LVM (Logical Volume Management), VMware vSAN level, or SVC (SAN Volume Controller), too, instead of storage server level.

Optionally, an additional layer may be applied to the data inspector 20, 40 to recognize logical volumes in a set of physical volumes.

This decoding may be applied to the trace logger 18, 38, too: the data inspector 20, 40 or the storage server element datastore 22, 42 provides a view on LVMs to trace logger to enable tracking of activity on logical volume level.

Advantageously the storage server element datastore 22, 42, respectively the landscape element datastore 66 provide a view on all storage servers 10, 30.

Data includes a timestamp of the last activity (recency) as well as server configuration data.

Interpretation of the data may be applied on top of raw data, e.g. based on when the last I/O activity occurred by the compute server 50. Servers which have not been active in defined time are considered unused. This implies orphaned volumes which could be considered for reaping, e.g. when an IP is used by several servers, one of which hasn't been active for months.

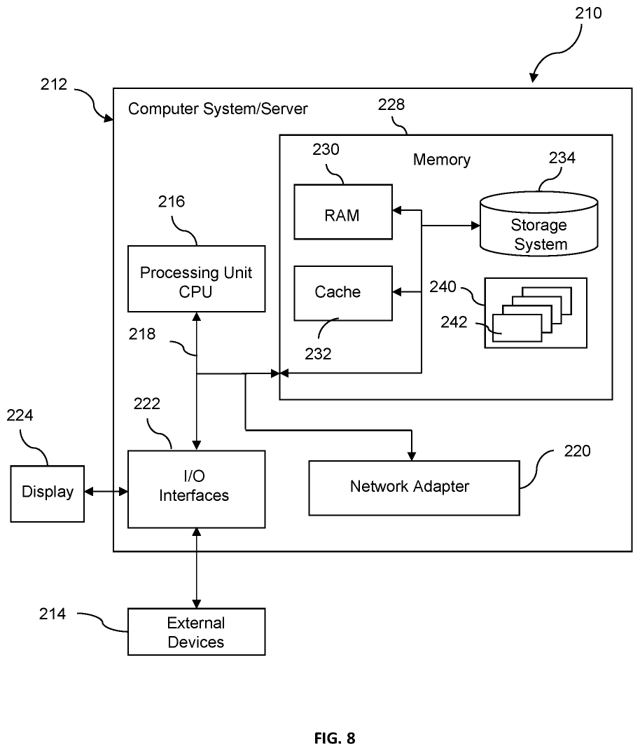

Referring now to FIG. 8, a schematic of an example of a data processing system 210 is shown. Data processing system 210 is only one example of a suitable data processing system and is not intended to suggest any limitation as to the scope of use or functionality of embodiments of the invention described herein. Regardless, data processing system 210 is capable of being implemented and/or performing any of the functionality set forth herein above.

In data processing system 210 there is a computer system/server 212, which is operational with numerous other general-purpose or special-purpose computing system environments or configurations. Examples of well-known computing systems, environments, and/or configurations that may be suitable for use with computer system/server 212 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 212 may be described in the general context of computer system executable instructions, such as program modules, being executed by a computer system. Generally, program modules may include routines, programs, objects, components, logic, data structures, and so on that perform particular tasks or implement particular abstract data types. Computer system/server 212 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 8, computer system/server 212 in data processing system 210 is shown in the form of a general-purpose computing device. The components of computer system/server 212 may include, but are not limited to, one or more processors or processing units 216, a system memory 228, and a bus 218 that couples various system components including system memory 228 to processor 216.

Bus 218 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 212 typically includes a variety of computer system readable media. Such media may be any available media that is accessible by computer system/server 212, and it includes both volatile and non-volatile media, removable and non-removable media.

System memory 228 can include computer system readable media in the form of volatile memory, such as random access memory (RAM) 230 and/or cache memory 232. Computer system/server 212 may further include other removable/non-removable, volatile/non-volatile computer system storage media. By way of example only, storage system 234 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 218 by one or more data media interfaces. As will be further depicted and described below, memory 228 may include at least one program product having a set (e.g., at least one) of program modules that are configured to carry out the functions of embodiments of the invention.

Program/utility 240, having a set (at least one) of program modules 242, may be stored in memory 228 by way of example, and not limitation, as well as an operating system, one or more application programs, other program modules, and program data. Each of the operating system, one or more application programs, other program modules, and program data or some combination thereof, may include an implementation of a networking environment. Program modules 242 generally carry out the functions and/or methodologies of embodiments of the invention as described herein.

Computer system/server 212 may also communicate with one or more external devices 214 such as a keyboard, a pointing device, a display 224, etc.; one or more devices that enable a user to interact with computer system/server 212; and/or any devices (e.g., network card, modem, etc.) that enable computer system/server 212 to communicate with one or more other computing devices. Such communication can occur via Input/Output (I/O) interfaces 222. Still yet, computer system/server 212 can communicate with one or more networks such as a local area network (LAN), a general wide area network (WAN), and/or a public network (e.g., the Internet) via network adapter 220. As depicted, network adapter 220 communicates with the other components of computer system/server 212 via bus 218. Although not shown, it should be understood that other hardware and/or software components could be used in conjunction with computer system/server 212. Examples, include, but are not limited to, microcode, device drivers, redundant processing units, external disk drive arrays, RAID systems, tape drives, and data archival storage systems, etc.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special-purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special-purpose hardware-based systems that perform the specified functions or acts or carry out combinations of special-purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for operating storage servers, the method comprising:
receiving an access request for at least one storage volume of at least one storage server;
collecting data for the at least one storage volume, wherein the at least one storage volume has a unique volume identifier; and
storing at least the data for the at least one storage volume and the unique volume identifier in a database, the data being comprised of metadata and subset data, wherein the metadata is comprised of configuration and status information for the at least one storage volume, and wherein the subset data is a set of predefined selection criteria based on a respective computer server.

2. The method of claim 1, wherein the access request includes at least an I/O request or an automatic request, the automatic request being generated following the expiration of a predetermined time interval.

3. The method of claim 1, further comprising:
assigning the respective computer server, a unique server identifier, wherein the respective computer server is one of a plurality of computer servers;
storing the unique server identifier with the data for the at least one storage volume and the unique volume identifier in the database using information processing.

4. The method of claim 1, further comprising:
registering a time stamp at the time data is collected for the at least one storage volume; and
storing the time stamp with the data for the at least one storage volume and the unique volume identifier in the database.

5. The method of claim of claim 1, further comprising:
querying the database using a network connection to the at least one storage server;
identifying each storage volume of the database;
determining a status for each of the storage volumes using a time stamp of a most recent I/O request for each unique volume identifier; and
deleting all database entries for each of the storage volumes with an inactive status, the inactive status being a predetermined length of time since the most recent I/O request associated with the unique volume identifier.

6. The method of claim 3, further comprising:
querying the database using a network connection to the at least one storage server;
identifying each of the plurality of computer servers of the database;
determining a status for each of the plurality of computer servers using a time stamp of a most recent I/O request for each unique server identifier; and
deleting all database entries for each of the plurality of computer servers with an inactive status, the inactive status being a predetermined length of time since the most recent I/O request associated with the unique server identifier.

7. The method of claim 1, wherein the at least one storage server has at least one subordinate storage server, the at least one subordinate storage server having a plurality of subordinate server databases.

8. The method of claim 7, further comprising:
querying the plurality of subordinate server databases using a network connection to the at least one storage server;
synchronizing the data extracted from the plurality of subordinate server databases using a landscape level aggregator; and
generating a landscape element database, wherein the landscape element database presents an aggregated view of the data extracted from the plurality of subordinate server databases.

9. The method of claim 8, wherein synchronizing the data extracted from the plurality of subordinate server databases further comprises:
correlating the data extracted from the plurality of subordinate server databases using unique identifiers of each subordinate server; and
deduplicating landscape elements of the data extracted from the plurality of subordinate databases.

10. The method of claim 8, wherein the landscape element database includes relationships between storage volumes of the plurality of subordinate server databases, and wherein the relationships are determined using mirror configurations.

11. A computer system for operating storage servers, comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
receiving an access request for at least one storage volume of at least one storage server;
collecting data for the at least one storage volume, wherein the at least one storage volume has a unique volume identifier; and
storing at least the data for the at least one storage volume and the unique volume identifier in a database, the data being comprised of metadata and subset data, wherein the metadata is comprised of configuration and status information for the at least one storage volume, and wherein the subset data is a set of predefined selection criteria based on a respective computer server.

12. The computer system of claim 11, wherein the at least one storage server has at least one subordinate storage server, the at least one subordinate storage server having a plurality of subordinate server databases.

13. The computer system of claim 12, further comprising:
querying the plurality of subordinate server databases using a network connection to the at least one storage server;
synchronizing the data extracted from the plurality of subordinate server databases using a landscape level aggregator; and
generating a landscape element database, wherein the landscape element database presents an aggregated view of the data extracted from the plurality of subordinate server databases.

14. The computer system of claim 13, wherein synchronizing the data extracted from the plurality of subordinate server databases further comprises:
correlating the data extracted from the plurality of subordinate server databases using unique identifiers of each subordinate server; and
deduplicating landscape elements of the data extracted from the plurality of subordinate databases.

15. The computer system of claim 13, wherein the landscape element database includes relationships between storage volumes of the plurality of subordinate server databases, and wherein the relationships are determined using mirror configurations.

16. A computer program product for operating storage servers, comprising:
one or more non-transitory computer-readable storage media and program instructions stored on at least one of the one or more tangible storage media, the program instructions executable by a processor to cause the processor to perform a method comprising:
receiving an access request for at least one storage volume of at least one storage server;
collecting data for the at least one storage volume, wherein the at least one storage volume has a unique volume identifier; and
storing at least the data for the at least one storage volume and the unique volume identifier in a database, the data being comprised of metadata and subset data, wherein the metadata is comprised of configuration and status information for the at least one storage volume, and wherein the subset data is a set of predefined selection criteria based on a respective computer server.

17. The computer program product of claim 16, wherein the at least one storage server has at least one subordinate storage server, the at least one subordinate storage server having a plurality of subordinate server databases.

18. The computer program product of claim 17, further comprising:
querying the plurality of subordinate server databases using a network connection to the at least one storage server;
synchronizing the data extracted from the plurality of subordinate server databases using a landscape level aggregator; and
generating a landscape element database, wherein the landscape element database presents an aggregated view of the data extracted from the plurality of subordinate server databases.

19. The computer program product of claim 18, wherein synchronizing the data extracted from the plurality of subordinate server databases further comprises:
correlating the data extracted from the plurality of subordinate server databases using unique identifiers of each subordinate server; and
deduplicating landscape elements of the data extracted from the plurality of subordinate databases.

20. The computer program product of claim 18, wherein the landscape element database includes relationships between storage volumes of the plurality of subordinate server databases, and wherein the relationships are determined using mirror configurations.
